(19) United States
(12) Patent Application Publication
(10) Pub. No.: US 2011/0161437 A1
(43) Pub. Date: Jun. 30, 2011

(54) ACTION-BASED E-MAIL MESSAGE QUOTA MONITORING

(75) Inventors: Susan M. Cox, Rochester, MN (US); Janani Janakiraman, Austin, TX (US); Fang Lu, Billerica, MA (US); Loulwa F. Salem, Austin, TX (US)

(73) Assignee: International Business Machines Corporation, Armonk, NY (US)

(21) Appl. No.: 12/651,065

(22) Filed: Dec. 31, 2009

(51) Int. Cl. G06F 15/16

(52) U.S. Cl. 709/206

(57) ABSTRACT

E-mail applications can be extended to allow recipients to specify quotas indicating maximum numbers of e-mail messages from specific senders based on actions indicated for the recipients to take. A sender can set a quota specifying that no more than five action related e-mail messages should be sent by each sender per week. Quotas may also be set for a number of e-mail messages received that do not require action. Recipient quota information is accessible by senders' e-mail applications so that senders are aware of the quotas before sending an e-mail message. After determining recipients for an e-mail message, an e-mail application can determine quotas for the recipients based on an action indicated in the e-mail message for the sender. The e-mail application can determine if the e-mail message to be sent will approach or reach the quota, and display a notification before the sender sends the e-mail message.

### BACKGROUND

Embodiments of the inventive subject matter generally relate to the field of e-mail applications, and, more particularly, to managing e-mail workload.

E-mail allows efficient business communication because communications can be delivered instantly. With e-mail being such a popular option for communication, e-mail inboxes can easily become inundated with requests and information. Reading and responding to e-mail messages can consume a large portion of the workday, leading to decreased productivity.

### SUMMARY

Embodiments include a method directed to determining an action requested of a recipient in regards to an e-mail message after the recipient is indicated for the e-mail message. In some embodiments, if an action based quota has been defined for e-mail messages sent to the recipient from a sender, it can be determined if the e-mail message is subject to the action-based quota based, at least in part, on the action requested of the recipient. If sending the e-mail message to the recipient will cause the action-based quota to be met or approached, a notification that sending the e-mail message to the recipient will cause the quota to be met or approached can be displayed.

Embodiments include a computer program product comprising a computer usable medium having computer usable program code. In some embodiments, the computer usable program code is configured to determine an action requested of a recipient in regards to an e-mail message after the recipient is indicated for the e-mail message. If an action based quota has been defined for e-mail messages sent to the recipient from a sender, it can be determined if the e-mail message is subject to the action-based quota based, at least in part, on the action requested of the recipient. If sending the e-mail message to the recipient will cause the action-based quota to be met or approached, a notification that sending the e-mail message to the recipient will cause the quota to be met or approached can be displayed.

Embodiments include an apparatus comprising one or more processing units, a network interface and an outbound e-mail manager. In some embodiments, the outbound e-mail manager can be operable to determine an action requested of a recipient in regards to an e-mail message after the recipient is indicated for the e-mail message. If an action based quota has been defined for e-mail messages sent to the recipient from a sender, it can be determined if the e-mail message is subject to the action-based quota based, at least in part, on the action requested of the recipient. If sending the e-mail message to the recipient will cause the action-based quota to be met or approached, a notification that sending the e-mail message to the recipient will cause the quota to be met or approached can be displayed.

### BRIEF DESCRIPTION OF THE DRAWINGS

The present embodiments may be better understood, and numerous objects, features, and advantages made apparent to those skilled in the art by referencing the accompanying drawings.

FIG. 1 is an example conceptual diagram of an e-mail application evaluating pending outbound e-mail messages against an action-based e-mail message quota.

FIG. 2 depicts a flowchart of example operations for regulating e-mail communications with action-based quotas.

FIG. 3 depicts a flowchart of example operations for defining an action-based quota.

FIG. 4 depicts an example computer system.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to e-mail applications, embodiments can be implemented in webmail applications. In other instances, well-known instruction instances, protocols, structures and techniques have not been shown in detail in order not to obfuscate the description.

Senders may not be aware of the number of e-mail messages they send to certain recipients over time. Increasing sender awareness of the volume of e-mail messages sent can reduce workload for e-mail message recipients because a sender may refrain from sending less important or redundant e-mail messages if aware that a large number of e-mail messages have been sent to a particular recipient over a short period of time. E-mail applications (e.g., IBM Lotus Notes® collaborative application, Microsoft Outlook® application, etc.) can be extended to allow recipients to specify quotas indicating maximum numbers of e-mail messages from specific senders based on actions (e.g., responding, reviewing, scheduling a meeting, etc.) indicated for the recipients to take. For example, a sender can set a quota specifying that no more than five action related e-mail messages (“action e-mail messages”) should be sent by each sender per week. Quotas may also be set for a number of e-mail messages received that do not require action (“reference e-mail messages”). Recipient quota information is accessible by senders' e-mail applications so that senders are aware of the quotas before sending an e-mail message. After determining recipients for an e-mail message, an e-mail application can determine quotas for the recipients based on an action indicated in the e-mail message for the sender. The e-mail application can determine if the e-mail message to be sent will approach or reach the quota, and display a notification before the sender sends the e-mail message.

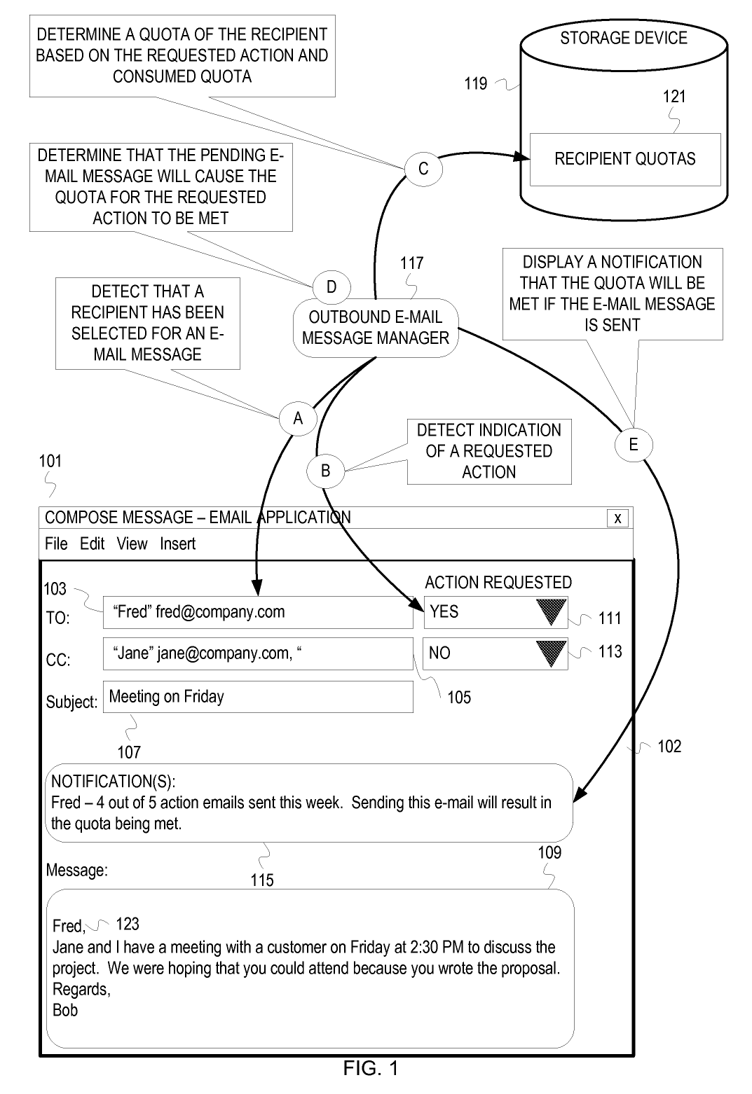

FIG. 1 is an example conceptual diagram of an e-mail application evaluating pending outbound e-mail messages against an action-based e-mail message quota. A sender is composing an e-mail message 102 in an e-mail application 101. A sender may have an individual identity or a group identity. The e-mail message 102 comprises a “TO” field 103, a carbon copy (“cc”) field 105, a “subject” field 107, an action requested field 111, an action requested field 113, a notification area 115, and a message field 109. The e-mail application 101 is associated with an outbound e-mail message manager 117. The outbound e-mail message manager 117 can be an extension of the application 101, a plug-in, third-party program, an operating system process, etc.

At stage A, the outbound e-mail message manager 117 detects that a recipient has been indicated for the e-mail message 102 in the TO field 103. In this example, the outbound e-mail message manager 117 detects that an e-mail address, fred@company.com, has been typed in the “to” field 103. As another example, the outbound e-mail manager 117 can detect that a contact has been selected from an address book. In embodiments, the e-mail application 101 can also notify the outbound e-mail message manager 117 of intended e-mail recipient individually or in a batch notification.

At stage B, the outbound e-mail message manager 117 detects indication of a requested action for the recipient. In this example, the outbound e-mail message manager 117 determines if action is requested based on the action requested field 111 that is associated with the “to” field 103 and the action requested field 113 associated with the “cc” field 105. The action requested field 111 indicates that an action is expected of fred@company.com regarding the e-mail message. The action requested field 113 indicates that action is not expected of jane@company.com regarding the e-mail message. Thus, the e-mail message is an action e-mail message from the perspective of fred@company.com and a reference e-mail message from the perspective of jane@company.com. The action requested fields 111 and 113 are represented by drop down boxes. If action is requested from a recipient, a user selects “yes” from the drop down box. If action is not requested (i.e., the e-mail is for the recipients reference), a user selects “no” from the drop down box. The outbound e-mail manager 117 can automatically determine whether action is expected of a recipient based on any one or more of text in the message field 109, a salutation, where a recipient appears in recipient fields (i.e., the “to” field 103, and the “cc” field 105), etc. For example, the outbound e-mail message manager 117 determines that “Fred” and “Jane” both appear in the message text 109. The outbound e-mail message manager 117 also determines that the e-mail message is addressed to “Fred” based on a salutation 123 that appears in the message 102. Because “Fred” is indicated in the “to” field 103 and in the salutation 123, the outbound e-mail message manager 117 can automatically determine that action is expected of “Fred.” Because “Jane” is indicated in the “cc” field 105 and does not appear in the salutation 123, the outbound e-mail message manager 117 determines that the e-mail is being sent to “Jane” for her reference so no action is expected of “Jane.” An e-mail outbound e-mail message manager can examines e-mail messages based on any one of heuristics, hard coded tips, learning techniques, etc.

At stage C, the outbound e-mail message manager 117 determines a quota of the recipient based on the expected action, and determines the consumed quota. In this example, the outbound e-mail message manager 117 determines the quota based on recipient quota preferences 121 stored in a storage device 119. The storage device 119 can be hosted on a computer that is running the e-mail application 101, on server accessible to the computer through a network, attached to the network as a network attached storage device, etc. In addition, the quota can be stored in a database local to the recipient e-mail account, in a profile of the recipient, a central repository of quotas, etc. The quota can indicate a maximum number of e-mail messages requesting action that the recipient wishes to receive from the sender in a specific period of time. The quota can also be based on the sender. For example, a quota can be defined as five action e-mail messages per week. The outbound e-mail message manager 117 determines that some amount of the quota has been consumed. For instance, 4 of 5 allowed action e-mail messages have been received this week from the sender. The consumed or exhausted amount of the quota can be retrieved with the quota, can be retrieved from a separate location, can be retrieved by querying the recipient e-mail account, etc.

At stage D, the outbound e-mail message manager 117 determines that the pending e-mail message will cause the quota for the requested action to be met. Embodiments can also associate notification thresholds or triggers with a quota to indicate when a number is approaching a quota. For example, a quota can be defined with a notification threshold of 90%. The outbound e-mail message manager 117 can determine that the pending e-mail message will cause the threshold to be met or passed, thus indicating that the quota is being approached.

At stage E, the outbound e-mail message manager 117 displays a notification indicating that Fred's action e-mail message quota for the sender will be met if the pending e-mail message is sent. In this example, the outbound e-mail message manager 117 displays the notification in the notification area 115. The notification states, “Fred—4 out of 5 action e-mail messages sent this week. Sending this e-mail will result in the quota being reached.” Embodiments can utilize one or more of color, sounds, animation, motion, etc. for notifying. The sender can evaluate the notification and the importance of the e-mail before sending the e-mail. If the sender determines that the e-mail is not critical, the sender can choose to discard the e-mail or send the e-mail later (e.g., after the end of the week when the consumed quota resets). If the pending e-mail message is sent, then a value representing the exhausted/consumed quota value is updated accordingly. Embodiments can update the exhausted/consumed quota value with any of the sending application, the receiving application, an intermediary application or process, etc. For instance, a process that monitors the recipient e-mail account can notify another process that maintains quota data to update the appropriate consumed/exhausted quota value.

Embodiments can define quotas with additional information about an action. To illustrate, a quota can be defined for actions that require attendance of a meeting and a different quota can be defined for actions that require generation of a document. Embodiments can associate expected time to complete to various actions, and define quotas based on the expected time to complete.

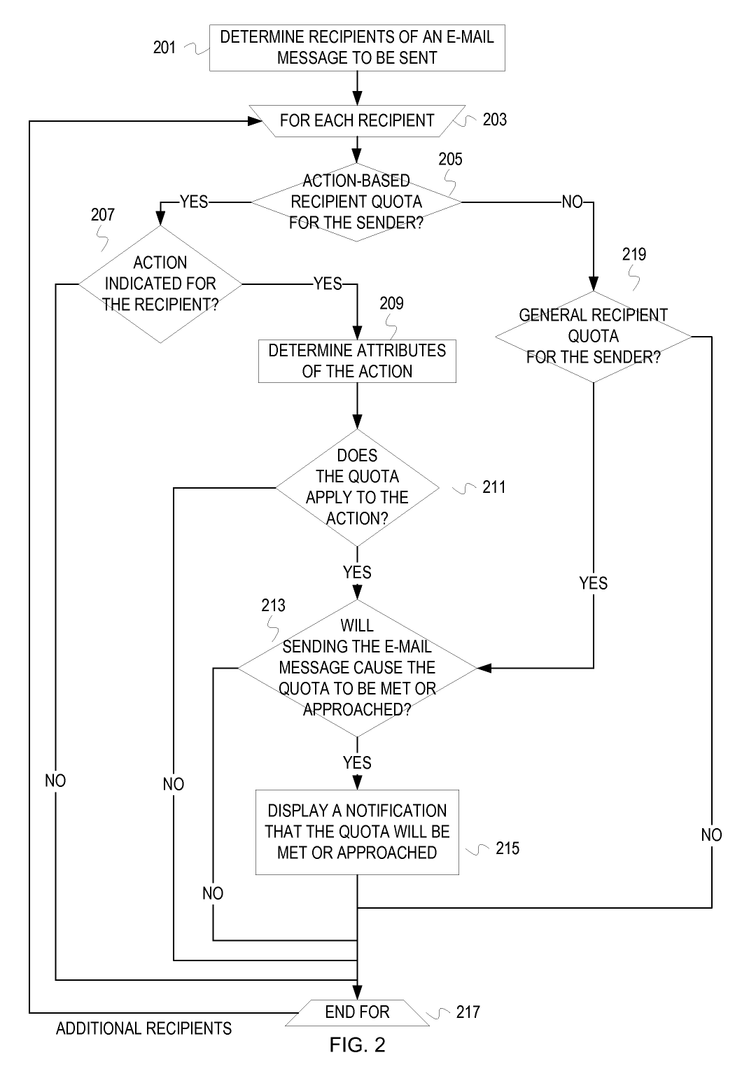

FIG. 2 depicts a flowchart of example operations for regulating e-mail communications with action-based quotas. Recipients of an e-mail message are determined (block 201). For example, the recipients can be determined by detecting selection of contacts from an address book.

A loop begins for each recipient indicated in the e-mail message (block 203). The operations of the loop determine whether sending a pending e-mail message will meet or approach a quota, thus triggering a notification.

It is determined if an action-based quota is indicated for the recipient (205). For example, an outbound e-mail message manager accesses quota data for the recipient. The outbound e-mail message manager can send a request to a process that manages the quota data. The process can then respond with data that indicates the quota definition. The process can be associated with a manager of web based e-mail accounts, running on a server associated with client e-mail applications, and/or a process or program that manages quota data separately from corresponding email accounts. The quota data can be associated with the recipient e-mail account or maintained separately. The quota data can be indexed by any one or more of username, actual name, e-mail address, etc. For example, the recipient may have set up a quota specifying that the recipient wishes to receive no more than 10 urgent e-mail messages from the sender in one month. Although quotas can be set for specific senders, default quotas can also be defined. Quotas for a specific sender can override the default quotas. If an action-based recipient quota is not indicated for the sender, then a general quota is evaluated (219). If an action-based recipient quota is indicated for the sender (207).

After determining that an action-based recipient quota has been indicated for the sender, it is determined if the action is indicated for the recipient to take (207). If not, then the operations continue on for the next recipient, if any.

If the action is indicated for the recipient, then attributes of the action are determined (209). For example, an outbound e-mail message manager can examine a body of an e-mail message to determine if the action involves attending a meeting, creating a presentation, or making a phone call. Embodiments can also solicit attribute information from a user via a user interface (e.g., tags, buttons, additional drop down menus, etc.). Embodiments can also determine attributes by mapping values indicated in the e-mail user interface to attribute data stored separately.

After the action attributes are determined, it is determined if the quota applies to the action based on the determined attributes (211). An outbound e-mail message manager can evaluate an action against conditions of a quota. Multiple quotas may be indicated for recipient. Each of the multiple quotas can be associated with a different action attribute. For example, a recipient may have a first quota of 10 e-mail messages per week for meeting actions from Bob. The recipient may also have a second quota of three e-mail messages per month for presentation actions from Bob. If the pending e-mail message indicates a presentation action for the recipient, then the second quota applies to the pending e-mail message to be sent from an account associated with Bob. If the quota does not apply to the action indicated in the pending e-mail message, then processing proceeds to the next recipient of the pending e-mail message.

If the quota applies to the action, then it is determined if sending the pending e-mail message will cause the quota to be met or approached (213). The outbound e-mail message manager can access data that indicates con consumed/exhausted quota. For example, the outbound e-mail message manager can access a provider that indicates any one of percentage of quota consumed, number of quota consumed, etc. if sending the pending e-mail message will not cause the quota to be met or approached, processing continues for the next indicated recipient of the pending e-mail message.

If the pending e-mail message will cause the quota to be met or approached, then a notification that the quota will be met or approached is displayed (215). For example, a red balloon appears with text indicating that the pending e-mail message will exhaust 80% of a recipient's action-based quota for the sender. A user can act upon the notification and/or processing continues on to the next indicated recipient of the pending e-mail message. As another example, a recipient's e-mail address may be displayed in red if the number of e-mail messages sent is approaching the quota, or in green if the number of e-mail messages sent is not near the quota. The number of e-mail messages sent and/or the quota can be displayed when a user places a mouse cursor over the recipient's e-mail address. Sounds can also be played to notify the sender.

If an action-based recipient quota was indicated for the sender, then it is determined if a general recipient quota is indicated for the sender (219). If a general recipient quota is indicated for the sender, then control flows to 213. If a general recipient quota is not indicated for the sender, processing continues on to the next indicated recipient.

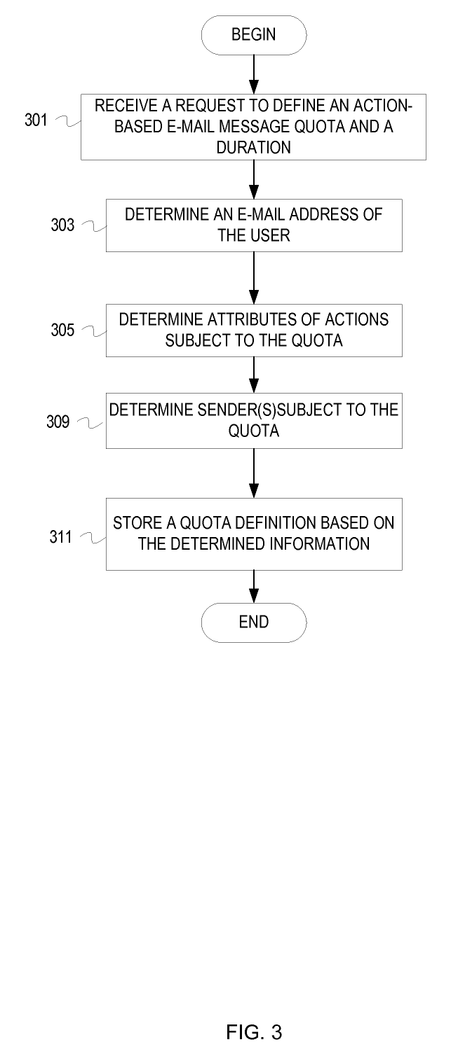

The quotas are defined by a recipient but are used when a sender wishes to send an e-mail to the recipient. The sender does not know the recipient's quota preferences unless the recipient notifies the sender of the preferences. FIG. 3 depicts a flowchart of example operations for defining an action-based quota. A request is received to define an action-based quota for e-mail messages for a duration (301). For example, the user can request an action-based quota of 20 e-mail messages per week.

An e-mail address(es) of the user is determined (303). The e-mail address can be determined from the request.

Attributes of actions subject to the quota are determined (block 305). Examples of attributes include type of action, time to complete action, action category, work product generated from action, etc. An attribute action can have one or more attributes indicated. For example, a first quota can be 10 e-mail messages per week for e-mail messages that request a telephonic response from the recipient while a second quota can be 25 e-mail messages per month for e-mail messages that are for the recipient's reference.

One or more senders subject to the quota are determined (309). For instance, the user can designate a group, individual, or any combination thereof as subject to the quota. The user can indicate senders by e-mail address, username, account identifier, etc. Embodiments can inform potential senders of the quota after the quota is defined/established.

A quota definition is stored based on the determined information (block 311). For example, the quotas can stored in a database associated with the user's e-mail application, can be stored in a database for an entity that manages the user's email account, can be stored by a third party, etc.

Although examples refer to recipients' requests to set up quotas being sent to a sender, embodiments are not so limited. For example, the recipient's e-mail application can store the quota preferences in a database that is accessible by the sender's e-mail application.

Embodiments are not limited to the example flowcharts depicted in the above figures. Embodiments can perform additional operations, fewer operations, operations in parallel, etc. For instance, referring to FIG. 2, operations can be performed to prevent sending the pending e-mail message if the quota has been met. Referring to FIG. 3, a single operation of parsing the request can determine a definition for an action-based e-mail message quota.

Embodiments may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

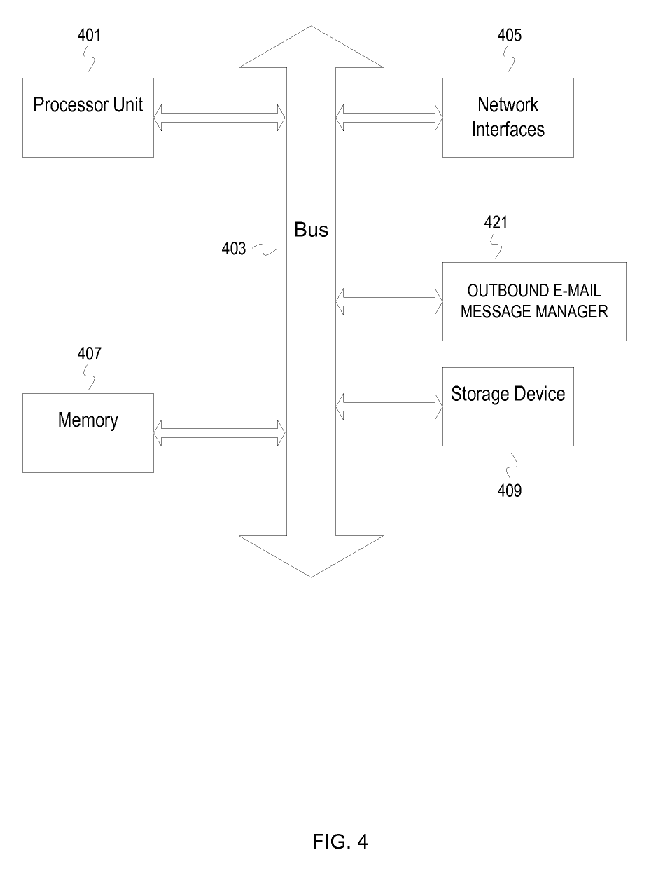

FIG. 4 depicts an example computer system. A computer system includes a processor unit 401 (possibly including multiple processors, multiple cores, multiple nodes, and/or implementing multi-threading, etc.). The computer system includes memory 407. The memory 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 403 (e.g., PCI, ISA, PCI-Express, HyperTransport®, InfiniBand®, NuBus, etc.), a network interface 405 (e.g., an ATM interface, an Ethernet interface, a Frame Relay interface, SONET interface, wireless interface, etc.), and a storage device(s) 409 (e.g., optical storage, magnetic storage, etc.). The computer system also includes an outbound e-mail message manager 421. The outbound e-mail message manager 421 monitors pending e-mail messages and generates a notification if sending a pending e-mail message will cause a recipient quota to be met or come within a threshold range. Any one of these functionalities may be partially (or entirely) implemented in hardware and/or on the processing unit 401. For example, the functionality may be implemented with an application specific integrated circuit, in logic implemented in the processing unit 401, in a co-processor on a peripheral device or card, etc. Further, realizations may include fewer or additional components not illustrated in FIG. 4 (e.g., video cards, audio cards, additional network interfaces, peripheral devices, etc.). The processor unit 401, the storage device(s) 409, and the network interface 405 are coupled to the bus 403. Although illustrated as being coupled to the bus 403, the memory 407 may be coupled to the processor unit 401.

While the embodiments are described with reference to various implementations and exploitations, it will be understood that these embodiments are illustrative and that the scope of the inventive subject matter is not limited to them. In general, techniques for managing e-mail workload as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
after a recipient is indicated for an e-mail message, determining an action requested of the recipient in regards to the e-mail message, wherein the e-mail message comprises an indication of the action, an indication of the recipient, an indication of a sender, and a message body;
determining that an action-based quota has been defined for e-mail messages sent to the recipient from a sender;
determining that the e-mail message is subject to the action-based quota based, at least in part, on the action requested of the recipient;
determining that sending the e-mail message to the recipient will cause the action-based quota to be met or approached; and
displaying a notification that sending the e-mail message to the recipient will cause the quota to be met or approached.

2. The method of claim 1, wherein said determining the action requested of the recipient in regards to the e-mail is based on, at least one of, input of the sender, text of the e-mail message, a subject of the e-mail message, a salutation in the e-mail message, and a location of the recipient in recipient fields.

3. The method of claim 1, wherein said determining that sending the e-mail message to the recipient will cause the action-based quota to be met or approached comprises determining a number of e-mail messages previously sent to the recipient that indicate actions similar to the action requested of the recipient with a time period of the action-based quota.

4. The method of claim 3, wherein the action-based quota indicates one of an action category, a time to complete an action, and an action priority.

5. The method of claim 1 further comprising updating a count of previously sent e-mail messages that consumed the quota after sending the e-mail message.

6. The method of claim 1 further comprising preventing the sender from sending subsequent e-mail messages to the recipient that indicate actions similar to the action requested of the recipient during a time period of the action-based quota.

7. The method of claim 1 further comprising determining a threshold for indicating when the action-based quota is being approached.

8. A computer program product for managing e-mail workload, the computer program product comprising:
a computer usable medium having computer usable program code embodied therewith, the computer usable program code comprising:
computer usable program code configured to,
after a recipient is indicated for an e-mail message, determine an action requested of the recipient in regards to the e-mail message, wherein the e-mail message comprises an indication of the action, an indication of the recipient, an indication of a sender, and a message body;
determine that an action-based quota has been defined for e-mail messages sent to the recipient from a sender;
determine that the e-mail message is subject to the action-based quota based, at least in part, on the action requested of the recipient;
determine that sending the e-mail message to the recipient will cause the action-based quota to be met or approached; and
display a notification that sending the e-mail message to the recipient will cause the quota to be met or approached.

9. The computer program product of claim 8, wherein the computer usable program code being configured to determine the action requested of the recipient in regards to the e-mail message is based on, at least one of, input of the sender, text of the e-mail message, a subject of the e-mail message, a salutation in the e-mail message, and a location of the recipient in recipient fields.

10. The computer program product of claim 8, wherein the computer usable program code being configured to determine that sending the e-mail message to the recipient will cause the action-based quota to be met or approached comprises the computer usable program code being configured to determine a number of e-mail messages previously sent to the recipient that indicate actions similar to the action requested of the recipient with a time period of the action-based quota.

11. The computer program product of claim 8, wherein the action-based quota indicates one of an action category, a time to complete an action, and an action priority.

12. The computer program product of claim 8, wherein the computer usable program code is further configured to update a count of previously sent e-mail messages that consumed the quota after sending the e-mail message.

13. The computer program product of claim 8, wherein the computer usable program code is further configured to prevent the sender from sending subsequent e-mail messages to the recipient that indicate actions similar to the action requested of the recipient during a time period of the action-based quota.

14. The computer program product of claim 8, wherein the computer usable program code is further configured to determine a threshold for indicating when the action-based quota is being approached.

15. An apparatus comprising:
a processing unit;
a network interface; and
an outbound e-mail message manager operable to,
after a recipient is indicated for an e-mail message, determine an action requested of the recipient in regards to the e-mail message, wherein the e-mail message comprises an indication of the action, an indication of the recipient, an indication of a sender, and a message body;
determine that a an action-based quota has been defined for e-mail messages sent to the recipient from a sender;
determine that the e-mail message is subject to the action-based quota based, at least in part, on the action requested of the recipient;
determine that sending the e-mail message to the recipient will cause the action-based quota to be met or approached; and
display a notification that sending the e-mail message to the recipient will cause the quota to be met or approached.

16. The apparatus of claim 15, wherein the outbound e-mail manager being operable to determine the action requested of the recipient in regards to the e-mail is based on, at least one of, input of a sender, text of the e-mail message, a subject of the e-mail message, a salutation in the e-mail message, a location of the recipient in recipient fields.

17. The apparatus of claim 15, wherein the outbound e-mail manager being operable to determine that sending the e-mail message to the recipient will cause the action-based quota to be met or approached comprises the outbound e-mail manager being operable to determine a number of e-mail messages previously sent to the recipient.

18. The apparatus of claim 15, wherein the action-based quota indicates one of an action category, a time to complete an action, and an action priority.

19. The apparatus of claim 15, wherein the outbound e-mail manager is further operable to update a count of previously sent e-mail messages that consumed the quota after sending the e-mail message.

20. The apparatus of claim 15, wherein the outbound e-mail manager is further operable to prevent sending of subsequent e-mail messages to the recipient that indicate actions similar to the action requested of the recipient during a time period of the action-based quota.
